(19) United States
(12) Patent Application Publication
(10) Pub. No.: US 2008/0033075 A1
(43) Pub. Date: Feb. 7, 2008

(54) Molded Elements Made Of Materials Containing Lignocellulose

(75) Inventors: Marco Schmidt, Speyer (DE); Christof Jackh, Heidelberg (DE); Dirk Funhoff, Mannheim (DE); Manfred Siegler, Frankenthal (DE); Jack R. Armstrong, Jersey City, NJ (US); Eugene K. Zimmerman, Washington, NJ (US); James T. Lyon, Novi, MI (US); Limei Lu, Canton, MI (US)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/596,978

(22) PCT Filed: May 21, 2005
(86) PCT No.: PCT/EP05/05522

§ 371 Date: Nov. 20, 2006

Related U.S. Application Data
(60) Provisional application No. 60/573,420, filed on May 24, 2004.

(51) Int. Cl. C08K 9/10

(52) U.S. Cl. 523/206

(57) ABSTRACT

The present invention provides moldings of lignocellulose materials comprising based on the weight of the molding 5-20% by weight of glue resin, and 2-30% by weight of microcapsules comprising a polymer wall and a core composed predominantly of latent heat storage materials.

The present specification relates to moldings of lignocellulose materials and a glue resin, to a process for producing them and to a binder composition comprising glue resin and microcapsules.

In buildings with modern architecture it is not uncommon to encounter large expanses of glass in combination with a lightweight interior architecture. One problem of such buildings is the introduction of heat through the large expanses of glass, trapping the heat within the building. The mass of such buildings is generally low and hence there is no mass at all for storing heat energy and hence acting as a buffer for peak temperatures.

The mass of the building materials in a building stores the instreaming heat by day in summer and so keeps the internal temperature (ideally) constant. In the cooler night time the stored heat is released again into the external air. In order to obtain a pleasant interior climate even in summer without active air conditioning, therefore, thermal mass is a must for the building. A large thermal mass of this kind is lacking from modern buildings, however, owing to their mode of construction.

Part of the interior fitting, such as ceilings, is nowadays made using chipboard. Chipboard, however, is completely unable to store heat, and instead has an insulating effect.

In recent years latent heat stores have been investigated as a new material combination in building materials. The way in which they operate is based on the enthalpy of transformation accompanying transition from the solid to the liquid phase or vice versa, which results in energy being absorbed from or released into the surroundings. They can therefore be used to maintain a constant temperature within a defined temperature range. Since depending on temperature the latent heat storage materials are also encountered in liquid form, they cannot be processed directly with building materials, since emissions into the ambient air and also separation from the building material would be likely adverse effects.

EP-A-1 029 018 teaches the use of microcapsules with a wall made of a highly crosslinked methacrylic ester polymer and a latent heat storage core in binding building materials such as concrete or gypsum. Since the walls of the capsules are only 5 to 500 nm thick, however, they are very sensitive to pressure, an effect which is exploited in their use in copy papers. It restricts their utility, however.

DE-A-101 39 171 describes the use of microencapsulated latent heat storage materials in plasterboard.

It was an object of the present invention to find further possibilities for effective heat storage and thus climate control in buildings.

This object is achieved by means of moldings of lignocellulose materials comprising based on the weight of the molding
5-20% by weight glue resin, calculated as solids, and
1-30% by weight microcapsules comprising a polymer wall and a core composed predominantly of latent heat storage materials.

The microcapsules present in the moldings of the invention are particles having a capsule core consisting predominantly—more than 95% by weight—of latent heat storage materials and a polymer wall. The capsule core is solid or liquid depending on temperature. The average particle size of the capsules (Z average as determined by light scattering) is from 0.5 to 100 μm, preferably from 1 to 80 μm, in particular from 1 to 50 μm. The weight ratio of capsule core to capsule wall is generally from 50:50 to 95:5. Preference is given to a core/wall ratio of from 70:30 to 90:10.

Latent heat storage materials are by definition substances which exhibit a phase transition in the temperature range in which heat transfer is to be performed. The latent heat storage materials preferably exhibit a solid/liquid phase transition in the temperature range from −20 to 120° C. Generally speaking, the latent heat storage media are organic substances, preferably lipophilic substances.

Examples of suitable substances include the following:
aliphatic hydrocarbon compounds such as saturated or unsaturated C₁₀-C₄₀ hydrocarbons which are branched or preferably linear, such as n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane and n-octacosane, and cyclic hydrocarbons, e.g., cyclohexane, cyclooctane and cyclodecane;
aromatic hydrocarbon compounds such as benzene, naphthalene, biphenyl, o- or n-terphenyl, C₁-C₄₀ alkyl-substituted aromatic hydrocarbons such as dodecylbenzene, tetradecylbenzene, hexadecylbenzene, hexylnaphthalene or decylnaphthalene;
saturated or unsaturated C₆-C₃₀ fatty acids such as lauric, stearic, oleic or behenic acid, preferably eutectic mixtures of decanoic acid with myristic, palmitic or lauric acid, for example;
fatty alcohols such as lauryl, stearyl, oleyl, myristyl and cetyl alcohol, mixtures such as coconut fatty alcohol, and also the oxo process alcohols obtained by hydroformylating α-olefins and further reactions;
C₆-C₃₀ fatty amines, such as decylamine, dodecylamine, tetradecylamine or hexadecylamine;
esters such as C₁-C₁₀ alkyl esters of fatty acids such as propyl palmitate, methyl stearate or methyl palmitate and, preferably, their eutectic mixtures, or methyl cinnamate;
natural and synthetic waxes such as montanic acid waxes, montan ester waxes, carnauba wax, polyethylene wax, oxidized waxes, polyvinyl ether wax, ethylene-vinyl acetate wax or hard waxes from Fischer-Tropsch processes;
halogenated hydrocarbons such as chlorinated paraffin, bromooctadecane, bromopentadecane, bromononadecane, bromoeicosane and bromodocosane.

Mixtures of these substances are also suitable, provided the melting point is not lowered to a point where it is outside the desired range, or the heat of fusion of the mixture is too low for sensible application.

It is advantageous, for example, to use plain n-alkanes, n-alkanes having a purity of more than 80% or alkane mixtures of the kind obtained as industrial distillate and available commercially.

It may be advantageous, moreover, to add to the capsule core-forming substances compounds which are soluble therein, so as to prevent the reduction in freezing point which occurs in some cases with the apolar substances. It is advantageous to use, as described in U.S. Pat. No. 5,456,852, compounds having a melting point 20 to 120 K higher than that of the actual core substance. Suitable, compounds are the fatty acids, fatty alcohols, fatty amides and aliphatic hydrocarbon compounds mentioned above as lipophilic substances. They are used in amounts of from 0.1 to 10% by weight, based on the capsule core.

The choice of latent heat storage materials depends on the temperature range within which the heat storage median are required. For example, for heat storage media in building materials in a moderate climate, preference is given to using latent heat storage materials whose solid/liquid phase transition is in the temperature range from 0 to 60° C. For interior applications, generally speaking, individual substances or mixtures having transformation temperatures of from 15 to 30° C. are chosen.

Preferred latent heat storage materials are aliphatic hydrocarbons, particularly those exemplified above. Particular preference is given to aliphatic hydrocarbons having 16, 17 or 18 carbon atoms and to mixtures thereof.

As the polymer for the capsule wall it is possible in principle to use the materials known for microcapsules for copy papers. Thus it is possible, for example, to encapsulate the latent heat storage materials in gelatin with other polymers by the methods described in GB-A 870476, U.S. Pat. No. 2,800,457 or U.S. Pat. No. 3,041,289.

Preferred wall materials on account of their great aging stability are thermosetting polymers. Thermosetting wall materials are those which on account of their high degree of crosslinking do not soften but instead break down at high temperatures. Examples of suitable thermosetting wall materials are highly crosslinked formaldehyde resins, highly crosslinked polyureas and highly crosslinked polyurethanes, and also highly crosslinked methacrylic ester polymers.

By formaldehyde resins are meant reaction products of formaldehyde with
triazines such as melamine
carbamides such as urea
phenols such as phenol, m-cresol and resorcinol
amino and amido compounds such as aniline, p-toluenesulfonamide, ethyleneurea and guanidine,
   or mixtures thereof.

Formaldehyde resins preferred as capsule wall material are urea-formaldehyde resins, urea-resorcinol-formaldehyde resins, urea-melamine resins and melamine-formaldehyde resins. Likewise preferred are the C₁-C₄ alkyl, particularly methyl, ethers of these formaldehyde resins and also mixtures with these formaldehyde resins. Particular preference is given to melamine-formaldehyde resins and/or their methyl ethers.

In the processes known from copy papers the resins are used as prepolymers. The prepolymer is still soluble in the aqueous phase and in the course of the polycondensation it migrates to the interface and surrounds the oil droplets. Processes for microencapsulation with formaldehyde resins are common knowledge and are described for example in EP-A-562 344 and EP-A 974 394.

Capsule walls made from polyureas and polyurethanes are likewise known from copy papers. The capsule walls are formed by reacting NH₂ and/or OH-carrying reactants with di- and/or polyisocyanates. Examples of suitable isocyanates are ethylene diisocyanate, 1,4-tetramethylene diisocyanate, 1,6-hexamethylene diisocyanate and 2,4- and 2,6-tolylene diisocyanate. Mention may also be made of polyisocyanates such as derivatives with biuret structure, polyuretonimines and isocyanurates. Suitable reactants include the following: hydrazine, guanidine and its salts, hydroxylamine, di- and polyamines and amino alcohols. Interface polyaddition processes of this kind are disclosed for example in U.S. Pat. No. 4,021,595, EP-A 0 392 876 and EP-A 0 535 384.

Preferred microcapsules are those whose capsule wall is a highly crosslinked methacrylic ester polymer. The degree of crosslinking is achieved with a crosslinker fraction≧10% by weight, based on the total polymer.

In preferred microcapsules the wall-forming polymers are composed of from 30 to 100% by weight, preferably from 30 to 95% by weight, of one or more C₁-C₂₄ alkyl esters of acrylic and/or methacrylic acid as monomers I. The polymers may also comprise in copolymerized form up to 80% by weight, preferably from 5 to 60% by weight, in particular from 10 to 50% by weight, of a di-functional or polyfunctional monomer, as monomers II, which is insoluble or of low solubility in water. The polymers may further comprise in copolymerized form up to 40% by weight, preferably up to 30% by weight, of other monomers III.

Suitable monomers I are C₁-C₂₄ alkyl esters of acrylic and/or methacrylic acid. Particularly preferred monomers I are methyl, ethyl, n-propyl and n-butylacrylate and/or the corresponding methacrylates. Preference is given to isopropyl, isobutyl, sec-butyl and tert-butyl acrylate and the corresponding methacrylates. Mention may also be made of methacrylonitrile. Generally speaking it is the methacrylates that are preferred.

Suitable monomers II are difunctional or polyfunctional monomers which are insoluble or of low solubility in water but have good to limited solubility in the lipophilic substance. Low solubility is understood to refer to a solubility of less than 60 g/l at 20° C. Difunctional or polyfunctional monomers are compounds having at least 2 nonconjugated ethylenic double bonds. Those principally coming into consideration are divinyl monomers and polyvinyl monomers, which bring about crosslinking of the capsule wall in the course of the polymerization.

Preferred difunctional monomers are the diesters of diols with acrylic acid or methacrylic acid, and also the diallyl and divinyl ethers of these diols.

Preferred divinyl monomers are ethanediol diacrylate, divinylbenzene, ethylene glycol dimethacrylate, 1,3-butylene glycol dimethacrylate, methallyl methacrylamide and allyl methacrylate. Particular preference is given to propanediol, butanediol, pentanediol and hexanediol diacrylates or the corresponding methacrylates.

Preferred polyvinyl monomers are trimethylolpropane triacrylate and trimethacrylate, pentaerithritol triallyl ether and pentaerythritol tetraacrylate.

Suitable monomers III are other monomers, preferably monomers IIIa such as styrene, α-methylstyrene, β-methylstyrene, butadiene, isoprene, vinyl acetate, vinyl propionate and vinylpyridine.

Particular preference is given to the water-soluble monomers IIIb, examples of which are acrylonitrile, methacrylamide, acrylic acid, methacrylic acid, itaconic acid, maleic acid, maleic anhydride, N-vinylpyrrolidone, 2-hydroxyethyl acrylate and methacrylate and acrylamido-2-methylpropanesulfonic acid. In addition, particular mention should be made of N-methylolacrylamide, N-methylolmethacrylamide, dimethylaminoethyl methacrylate and diethylaminoethyl methacrylate.

The microcapsules suitable for use in accordance with the invention can be produced by an in situ polymerization.

The preferred microcapsules and their production are known from EP-A-457 154, DE-A-10 139 171, DE-A-102 30 581, EP-A-1 321 182, expressly incorporated by reference. Thus the microcapsules are produced by preparing a stable oil-in-water emulsion from the monomers, a free-radical initiator, a protective colloid and the lipophilic substance for encapsulating, these components being present as the disperse phase in the emulsion. Subsequently the polymerization of the monomers is initiated by heating and controlled by further increasing temperature, the polymers produced forming the capsule wall which envelops the lipophilic substance.

The polymerization is carried out in general at from 20 to 100° C., preferably at from 40 to 80° C. The dispersion temperature and polymerization temperature should of course be above the melting temperature of the lipophilic substances.

On reaching the final temperature, the polymerization is advantageously continued for a period of up to 2 hours in order to reduce the levels of residual monomer. Following the polymerization reaction proper, at a conversion of from 90 to 99% by weight, it is generally advantageous substantially to free the aqueous microcapsule dispersions from odoriferous substances, such as residual monomers and other volatile organic constituents. This can be done by conventional means, physically, by distillative removal (in particular by steam distillation) or by stripping with an inert gas. It may also take place chemically, as described in WO 9924525, advantageously by means of redox-initiatied polymerization, as described in DE-A-4 435 423, DE-A-4419518 and DE-A-4435422.

In this way it is possible to produce microcapsules having an average particle size in the range from 0.5 to 100 μm, the particle size being adjustable conventionally by way of the shearing force, stirring speed, protective colloid and concentration thereof.

Preferred protective colloids are water-soluble polymers, since these lower the surface tension of water from a maximum of 73 mN/m to 45-70 mN/m and hence ensure the formation of closed capsule walls and of microcapsules having preferred particle sizes of between 1 and 30 μm, particularly 3 and 12 μm.

Generally speaking, the microcapsules are produced in the presence of at least one organic protective colloid, which can be either anionic or neutral. Anionic and nonionic protective colloids together can be used as well. Preference is given to using inorganic protective colloids alone or in a mixture with organic protective colloids.

Neutral organic protective colloids are cellulose derivatives such as hydroxyethylcellulose, carboxymethylcellulose and methylcellulose, polyvinylpyrrolidone, vinylpyrrolidone copolymers, gelatin, gum arabic, xanthan, sodium alginate, casein, polyethylene glycols, preferably polyvinyl alcohol and partially hydrolyzed polyvinyl acetates.

Suitable anionic protective colloids include polymethacrylic acid, the copolymers of sulfoethyl acrylate and methacrylate, sulfopropyl acrylate and methacrylate, N-sulfoethylmaleimide, 2-acrylamido-2-alkylsulfonic acids, styrenesulfonic acid and vinylsulfonic acid.

Preferred anionic protective colloids are naphthalenesulfonic acid and naphthalene-sulfonic acid-formaldehyde condensates, and also, in particular, polyacrylic acids and phenolsulfonic acid-formaldehyde condensates.

The anionic protective colloids are used generally in amounts of from 0.1 to 10% by weight, based on the water phase of the emulsion.

Preference is given to inorganic protective colloids known as Pickering systems, which permit stabilization by means of very fine solid particles and are insoluble in water but dispersible or insoluble and not dispersible in water but can be welted by the lipophilic substance.

The way in which they work, and their use, are described in EP-A-1 029 018 and also EP-A-1 321 182, the content of which is expressly incorporated by reference.

A Pickering system can consist of the solid particles alone or, in addition, of auxiliaries which enhance the dispersibility of the particles in water or the wettability of the particles by the lipophilic phase.

The inorganic solid particles can be metal salts, such as salts, oxides and hydroxides of calcium, magnesium, iron, zinc, nickel, titanium, aluminum, silicon, barium and manganese. Compounds to be mentioned are magnesium hydroxide, magnesium carbonate, magnesium oxide, calcium oxalate, calcium carbonate, barium carbonate, barium sulfate, titanium dioxide, aluminum oxide, aluminum hydroxide and zinc sulfide. Silicates, bentonite, hydroxyapatite and hydrotalcites may also be mentioned. Particular preference is given to highly disperse silicas, magnesium pyrophosphate and tricalcium phosphate.

The Pickering systems can be added first to the water phase and also added to the stirred oil-in-water emulsion. Many fine, solid particles are prepared by precipitation, as described in EP A-1 029 018 and also EP-A-1 321 182.

The highly disperse silicas can be dispersed as fine, solid particles in water. It is also possible, however, to use what are called colloidal dispersions of silica in water. The colloidal dispersions are alkaline, aqueous mixtures of silica. In the alkaline pH range the particles are swollen and stable in water. For the use of these dispersions as a Pickering system it is advantageous if the pH during the oil-in-water emulsion is adjusted from 2 to 7 using an acid.

The inorganic protective colloids are used in general in amounts of from 0.5 to 15% by weight, based on the water phase.

In general the neutral organic protective colloids are used in amounts of from 0.1 to 15% by weight, preferably from 0.5 to 10% by weight, based on the water phase.

The dispersing conditions for preparing the stable oil-in-water emsulsion are preferably chosen, in a conventional manner, so that the oil droplets have the size of the desired microcapsules.

The microcapsules can be incorporated into glue resins commonly used for lignocellulose materials.

Lignocellulose materials in accordance with the prior art are for example wood chips obtained from chipped wooden logs and billets, sawmill and veneer wastes, planing and peeler shavings, and other lignocellulose raw materials, e.g. bagasse, flax shives, cotton stalks, jute, sisal, straw, flax, coconut fibers, banana fibers, hemp and cork. Wood fibers or wood chips are particularly preferred. The raw materials may be in the form of granules, flour or, preferably, chips, fibers and/or shavings.

Preferred glue resins are amino resins, phenolic resins, isocyanate resins and polycarboxylic acid resins.

Suitable amino resins include binders based on formaldehyde condensates of urea or of melamine. They are in commerce in the form of aqueous solutions or powder under the names Kaurit® and Kauramin® (manufacturer: BASF) and comprise urea- and/or melamine-formaldehyde precondensates. Condensates and cocondensates, which may comprise further constituents such as phenol or else different aldehydes, are customary. Suitable amino resins and phenolic resins are urea-melamine-formaldehyde condensates, melamine-urea-formaldehyde-phenol condensates, phenol-formaldehyde condensates, phenol-resorcinol-formaldehyde condensates, urea-formaldehyde condensates and melamine-formaldehyde condensates, and mixtures thereof. Their preparation and use are general art knowledge. The precondensation of the starting materials is generally taken to a viscosity of from 200 to 500 mPas (based on a 66% strength by weight resin solution).

Preference is given to urea-formaldehyde resins, particularly those featuring a molar ratio of 1 mol of urea to from 1.1 to 1.4 mol of formaldehyde.

In the course of the processing of amino resins there is a transition of the soluble and meltable amino resin precondensates to unmeltable and insoluble products. This process, which is referred to as curing, is known to be accompanied by comprehensive crosslinking of the precondensates, generally accelerated by means of curing agents.

Curing agents which can be used include the curing agents known to the skilled worker for urea-, phenol- and/or melamine-formaldehyde resins, such as compounds which give an acidic reaction and/or give off acid, examples being ammonium salts or amine salts. The curing agent fraction in a glue resin liquor is generally from 1 to 5% by weight, based on the liquid resin fraction.

Suitable isocyanate resins include all customary resins based on methylene-diphenylene isocyanates (MDI). They are composed in general of a mixture of monomers, polymers and oligomeric diisocyanates, referred to as precondensates, which are capable of reacting with the cellulose, the lignin and the moisture in the wood. The resin content of moldings produced using them is generally 3-5% by weight, based on the molding.

Suitable isocyanate resins are available commercially for example as Lupranat® grades (from Elastogran).

Further suitable glue resins include polycarboxylic acid resins which comprise
A) a polymer obtained by free-radical addition polymerization and composed of from 5 to 100%, preferably from 5 to 50%, by weight of an ethylenically unsaturated acid anhydride or, preferably, an ethylenically unsaturated dicarboxylic acid whose carboxylic acid groups are able to form an anhydride group (monomers a)) and 0-95%, preferably from 50 to 95%, by weight of monomers b), which are different than the monomers a), and
B) an alkanolamine having at least two hydroxyl groups.

Resins of this kind are described in EP-A-882 093, expressly incorporated by reference.

Particularly preferred polymers are those which comprise as monomers a) maleic acid and/or maleic anhydride.

Preferred monomers b) are acrylic acid, methacrylic acid, ethene, propene, butene, isobutene, cyclopentene, methyl vinyl ether, ethyl vinyl ether, acrylamide, 2-acrylamido-2-methylpropanesulfonic acid, vinyl acetate, styrene, butadiene, acrylonitrile or mixtures thereof. Particular preference is given to acrylic acid, methacrylic acid, ethene, acrylamide, styrene and acrylonitrile or mixtures thereof.

Particular preference is given to those polymers in which the monomer b) comprises at least one C₃-C₆ monocarboxylic acid, preferably acrylic acid, as comonomer b).

The polymers can be prepared by customary polymerization processes, such as by bulk, emulsion, suspension, dispersion, precipitation and solution polymerization. For all polymerization methods the customary apparatus is used, examples being stirred tanks, stirred tank cascades, autoclaves, tube reactors and kneading apparatus. As will be familiar to the skilled worker, these methods are carried out in the absence of oxygen. It is preferred to operate by the method of solution polymerization and emulsion polymerization. The polymerization is carried out in water, where appropriate with fractions up to 60% by weight of alcohols or glycols as solvent or diluent.

Where polymerization takes place in aqueous solution or dilution, all or some of the ethylenically unsaturated carboxylic acids can be neutralized by bases before or during the polymerization. Examples of suitable bases include alkali metal and alkaline earth metal compounds, ammonia, primary, secondary and tertiary amines such as diethanolamine and triethanolamine, and polybasic amines.

With particular preference the ethylenically unsaturated carboxylic acids are neutralized neither before nor during the polymerization. Preferably no neutralizing agent, apart from the alkanolamine B), is added after the polymerization, either.

The conduct of the polymerization can be conducted in accordance with a multiplicity of variants, continuously or batchwise. It is usual to introduce initially a portion of the monomers, if appropriate in a suitable diluent or solvent and if appropriate in the presence of an emulsifier, a protective colloid or further auxiliaries, to form an initial charge, to render this initial charge inert, and to raise the temperature until the desired polymerization temperature is reached. Over the course of a defined period of time the free-radical initiator, further monomers and other auxiliaries, such as regulators or crosslinkers, in each case in a diluent if appropriate, are metered in.

The polymers A) are preferably in the form of an aqueous dispersion or solution having solids contents of preferably from 10 to 80% by weight, in particular from 40 to 65% by weight.

As component B) use is made of alkanolamines having at least two OH groups, such as diethanolamine, triethanolamine, diisopropanolamine, triisopropanolamine, methyldiethanolamine, butyldiethanolamine and methyldiisopropanolamine. Triethanolamine is preferred.

The polycarboxylic acid resins are prepared using the polymer A) and the alkanolamine B) preferably in a ratio to one another such that the molar ratio of carboxyl groups of component A) to the hydroxyl groups of component B) is from 20:1 to 1:1, preferably from 8:1 to 1.5:1 and more preferably from 5:1 to 1.7:1 (the anhydride groups are counted as 2 carboxyl groups in this context).

The polycarboxylic acid resins are prepared, for example, simply by adding the alkanolamine to the aqueous dispersion or solution of the polymers A).

The microcapsules can be added to the mixture of wood fibers and/or wood chips and binder that serves as a basis for the molding in a variety of ways and at different points in the manufacturing operation.

The microcapsules can be incorporated into the binder composition, in powder form or, preferably, as a dispersion. From 2 to 30% by weight, preferably from 5 to 15% by weight, of microcapsules are incorporated, based on the molding. It is likewise possible, however, to dry the microcapsules in a first step together with the lignocellulose materials and then to subject the mixture to thermal curing with the glue resin.

The present invention further provides binder compositions comprising 40-95% by weight, preferably 40-65% by weight, in particular 50-60% by weight of glue resin, calculated as solids, 5-40% by weight, preferably 10-35% by weight, in particular 20-30% by weight of microcapsules and, if appropriate, water, based on 100% by weight of binder composition.

In addition it is possible together with the glue resins for moldings of lignocellulose materials to use customary auxiliaries and additives such as the curing agents already mentioned above, buffers, insecticides, fungicides, fillers, hydrophobicizing agents such as silicone oils, paraffins, waxes, fatty soaps, water retention agents, wetting agents and flame retardants such as borates and aluminum hydroxide. Accordingly these auxiliaries and additives may also be present in the binder compositions of the invention.

The moldings of the invention are boards in particular. Depending on the size of the lignocellulosic particles employed a distinction is made between OSB (oriented structural board), chipboard and medium (MDF) and high density (HDF) fiber board. The binder composition of the invention is used with preference for wood particle materials, especially boards.

The lignocellulose materials can be coated directly with the microcapsules or with the binder composition of the invention. According to one version of the process the lignocellulose materials are mixed with the binder composition and this mixture is cured thermally, the binder composition comprising 40-95% by weight of glue resin and 5-40% by weight of microcapsules having a polymer capsule wall and a capsule core composed predominantly of latent heat storage materials and 0-20% by weight of water.

According to one version of the process from 9 to 30%, preferably from 12 to 20%, by weight of the aqueous binder composition is added to the lignocellulose materials, based on the total amount of lignocellulose material and binder composition.

The viscosity of the aqueous binder composition is adjusted preferably (and particularly when producing moldings from wood fibers or wood chips) to from 10 to 10 000, more preferably from 50 to 1500 and very preferably from 100 to 1000 mPa·s (DIN 53019, rotational viscometer at 41 sec⁻¹).

The mixture of lignocellulose materials and the binder composition can be predried, for example, at temperatures of from 10 to 150° C. and then pressed to form the moldings at temperatures for example of from 50 to 300° C., preferably from 100 to 250° C. and more preferably from 140 to 225° C. under pressures of in general from 2 to 200 bar, preferably from 5 to 100 bar and more preferably from 20 to 50 bar to form the moldings. Despite the high molding temperatures in combination with the pressures there is, surprisingly, no destruction of the microcapsules, despite the fact that the molding temperatures are generally above the softening temperatures of the capsule wall materials.

The binder compositions of the invention are especially suitable for producing wood base materials such as wood particle board and wood fiber board (cf. Ullmanns Encyclopädie der technischen Chemie, 4th edition, 1976, Volume 12, pp. 709-727), which can be produced by gluing together comminuted wood such as wood chips and wood fibers, for example.

The production of chipboard is common knowledge and is described for example in H. J. Deppe, K. Ernst, Taschenbuch der Spanplattentechnik, 2nd edition, Leinfelden 1982.

Chipboard is produced by applying resin to the pre-dried chips in continuous mixers. Commonly a variety of chip fractions are resinated differently in separate mixers and then formed into mat separately (multilayer board) or jointly. The microcapsules may be added to the chips in aqueous solution upstream of the dryer, in a continuous mixer, or in the course of resination, together with or separately from the resin. A combination of the two methods is also possible.

It is preferred to use chips whose average thickness is from 0.1 to 2 mm, in particular from 0.2 to 0.5 mm, and which comprise less than 6% by weight of water. The binder composition is applied very uniformly to the wood chips, by spraying the binder composition in finely divided form onto the chips, for example.

The resinated wood chips are subsequently spread out to form a layer with a surface as uniform as possible, the thickness of the layer being governed by the desired thickness of the finished board. The scattered layer is subjected to cold precompression if appropriate and is pressed to form a dimensionally stable board at a temperature of, for example, from 100 to 250° C., preferably from 140 to 225° C., applying pressures of usually from 10 to 750 bar. The press times required may vary within a wide range and are in general between 15 seconds and 30 minutes.

The wood fibers of suitable quality required to produce medium density fiber board (MDF) from the binders may be produced from bark-free wood chips by grinding in specialty mills or refiners, as they are known, at temperatures of approximately 180° C.

In the production of MDF and HDF the fibers are resinated in the blow line downstream of the refiner. For resination, the wood fibers are generally swirled up in a stream of air and the binder composition is introduced through nozzles into the resultant fiber stream (blow-line process). The resinated fibers then pass through a dryer, which dries them to a residual moisture content of from 7 to 13% by weight. Occasionally the fibers are dried first and resinated subsequently in special continuous mixers. A combination of blow line and mixer resination is also possible. The addition of the microcapsules to the fibers can take place in aqueous solution in the blow line together with or separately from the resin. The ratio of wood fibers to the binder composition, based on the dry matter content or solids content, is normally from 40:1 to 3:1, preferably from 20:1 to 4:1. The resinated fibers are dried in the fiber stream at temperatures of from 130 to 180° C., for example, spread out to form a fiber mat and subjected to cold precompression, if appropriate, and then pressed under pressures of from 20 to 40 bar to form boards or moldings.

In OSB manufacture the wood chips (strands) are dried to a residual moisture content of 1-4%, separated into center layer and outside layer material, and resinated separately in continuous mixers. The addition of the microcapsules to the wood chips can take place in aqueous solution upstream of the dryer, in a continuous mixer, or in the course of resination, together with or separately from the resin. A combination of the two methods is also possible.

To complete the boards, the resinated wood chips are then formed into mats, subjected to cold precompression if appropriate, and pressed in heated presses at temperatures from 170 to 240° C. to form boards.

The resinated wood fibers can also be processed to a transportable fiber mat as described in DE A 2 417 243. This semifinished product can then be processed further in a second, temporarily and spatially separate step to form boards or moldings, such as door interior linings for motor vehicles, for example.

The binder compositions of the invention are additionally suitable for producing plywood and carpentry board by the production processes, which are common knowledge.

Other abovementioned natural fiber materials as well, such as sisal, jute, hemp, straw, flax, coconut fibers, banana fibers and other natural fibers, can be processed with the binders to form boards and moldings. The natural fiber materials can also be used in mixtures with polymeric fibers, e.g., polypropylene, polyethylene, polyesters, polyamides or polyacrylonitrile. These polymeric fibers may also act as cobinders alongside the binder composition of the invention. The fraction of the polymeric fibers in that case is preferably less than 50% by weight, in particular less than 30% by weight and very preferably less than 10% by weight, based on all chips, shavings or fibers. The fibers can be processed by the methods which are utilized for wood fiber board. An alternative option is to impregnate preformed natural fiber mats with the binders of the invention, with the addition if appropriate of a wetting assistant. The impregnated mats are then pressed in the binder-moist or predried state at temperatures of between 100 and 250° C. and pressures of between 10 and 100 bar, for example, to form boards or moldings.

The moldings of the invention, particularly the chipboard panels, are outstandingly suitable for interior applications such as wall and ceiling paneling. They can also have their surfaces enhanced by coating for producing furniture and laminate flooring, for example. They have good heat storage properties. Unexpectedly the boards of the invention give good results for water absorption and also increased thickness after water storage.

The examples which follow are intended to describe the invention in more detail:

Preparation of the microcapsules:

Water phase:

| | | |
|---|---|---|
| 572 | g | water |
| 80 | g | a 50% by weight colloidal dispersion of SiO₂ in water with |
| | | a pH of 9.3 (average particle size 108.6 nm, Z-average |
| | | value by light scattering) |
| 2.1 | g | a 2.5% strength by weight aqueous sodium nitrite solution |
| 20 | g | a 1% by weight aqueous methylcellulose solution |
| | | (viscosity 15 000 mPas at 2% in water) |

Oil phase

| | | |
|---|---|---|
| 440 | g | C₁₆-C₁₈ alkane mixture (26° C. melting temperature) |
| 77 | g | methyl methacrylate |
| 33 | g | butanediol diacrylate |
| 0.76 | g | ethylhexyl thioglycolate |
| 1.35 | g | t-butyl perpivalate |

Feed 1: 1.09 g t-butyl hydroperoxide, 70% by weight in water
Feed 2: 0.34 g ascorbic acid, 0.024 g NaOH, 56 g H₂O

The above water phase was introduced initially at room temperature and adjusted to a pH 4 using 3 g of 10% strength nitric acid. Addition of the oil phase was followed by dispersion using a high-speed dissolver stirrer at 4800 rpm. After 40 minutes of dispersing a stable emulsion was obtained with a particle size of from 1 to 9 μm in diameter. While being stirred with an anchor stirrer, the emulsion was heated to 56° C. over 40 minutes, to 58° C. over the course of a further 20 minutes, to 71° C. over the course of a further 60 minutes and to 85° C. over the course of a further 60 minutes. The resulting microcapsule dispersion was cooled to 70° C. with stirring and feed 1 was added. Feed 2 was metered in with stirring at 70° C. over 80 minutes. The mixture was subsequently cooled. The resultant microcapsule dispersion possessed a solids content of 47.2% by weight and an average particle size of 5.8 μm (volume average value, measured by means of Fraunhofer diffraction).

The dispersion was dried without problems in a laboratory spray dryer with two-fluid nozzle and cyclone separation, the entry temperature of the heating gas being 130° C. and the exit temperature of the powder from the spraying tower 70° C. When heated in differential calorimetry at a heating rate of 1 K/minute, microcapsule dispersion and powder showed a melting point between 24.5 and 27.5° C. with a conversion enthalpy of 110 J/g alkane mixture.

### EXAMPLE 1

### Chipboard with Latent Heat Store

5400 g of dried chips were coated through a nozzle with 1628 g of a mixture of

| | |
|---|---|
| Urea-formaldehyde resin, 68% | 100.0 g |
| Paraffin emulsion, 60% | 6.3 g |
| Ammonium nitrate solution, 52% strength | 4.0 g |
| Microcapsules, 42% | 23.5 g |
| Microcapsules, powder | 14.8 g |

and 3370 g of the resulting resinated chips were tipped into a mold (56.5 cm×44 cm). The material was pressed to a thickness of 18 mm in a press at 190° C. in 230 s to form a chipboard.

The chipboard comprised 14% resin solids/dry chips, 0.5% wax solids/dry chips and 5% microcapsules/dry chips.

Testing of the chipboard:

Thickness increase (swelling): The percentage increase in the thickness of the board following water storage was determined using a vernier.

Properties of the chipboard:

| | | |
|---|---|---|
| Thickness | mm | 18.0 |
| Density | kg/m³ | 689 |
| Transverse tensile strength, dry | N/mm² | 0.70 |
| Swelling after 2 h water storage | % | 1.8 |
| Swelling after 24 h water storage | % | 11.0 |

### EXAMPLE 2

### MDF Board with Latent Heat Store

1000 g of dry fibers were coated through nozzles with 50 g of microcapsules in 42% form and with a resin batch made up of

| | |
|---|---|
| Urea-formaldehyde resin, 68% | 100.0 g |
| Paraffin emulsion, 60% | 3.2 g |
| Water | 11.8 g |

and dried to a moisture content of 8%. 920 g of the dried, resinated fibers were tipped into a mold (30 cm×30 cm). The material was pressed to a thickness of 12 mm in a press at 190° C. in 300 s to form an MDF board.

The MDF board comprised 14% resin solids/dry fiber, 0.5% wax solids/dry fiber and 5% microcapsules/dry fibers.

Properties of the MDF board.

| | | |
|---|---|---|
| Thickness | mm | 10.7 |
| Density | kg/m³ | 744 |
| Transverse tensile strength | N/mm² | 0.95 |
| Swelling after 2 h water storage | % | 2.2 |
| Swelling after 24 h water storage | % | 7.1 |

1. A molding of lignocellulose materials comprising based on its weight
5-20% by weight of glue resin, calculated as solids, and
1-30% by weight of microcapsules comprising a polymer wall and a core composed predominantly of latent heat storage materials.

2. The molding according to claim 1, wherein the glue resin is at least one resin selected from the group of resins consisting of amino resins, phenolic resins, isocyanate resins and polycarboxylic acid resins.

3. The molding according to claim 1, wherein the glue resin comprises one or a combination of a urea-formaldehyde and a melamine-formaldehyde resin.

4. The molding according to claim 1, wherein the latent heat storage materials are lipophilic substances having a solid/liquid phase transition in the temperature range from −20 to 120° C.

5. The molding according to claim 1, wherein the latent heat storage materials are aliphatic hydrocarbon compounds.

6. The molding according to claim 1, wherein the capsule wall is a highly crosslinked methacrylic ester polymer.

7. The molding according to claim 1, wherein the capsule wall is composed of
30 to 100% by weight of one or more C₁-C₂₄ alkyl esters of acrylic acid, methacrylic acid or a mixture thereof,
0 to 80% by weight of a difunctional or polyfunctional monomer which is insoluble or of low solubility in water and
0 to 40% by weight of other monomers,
based in each case on the total weight of the monomers.

8. The molding according to claim 1, wherein the microcapsules are obtainable by heating an oil-in-water emulsion containing the monomers, a free-radical initiator and the latent heat storage materials as disperse phase.

9. The molding according to claim 1, obtainable by mixing the lignocellulose materials with a binder composition comprising
40-95% by weight glue resin, calculated as solids,
5-40% by weight microcapsules comprising a polymer wall and a core composed predominantly of latent heat storage materials and
0-20% by weight water
and thermally curing the mixture.

10. A process for producing a molding according to claim 1, which comprises drying the lignocellulose materials together with the microcapsules and then subjecting them to thermal curing with the glue resin.

11. A process for producing a molding according to claim 9, which comprises mixing the lignocellulose materials with a binder composition comprising
40-95% by weight glue resin, calculated as solids,
5-40% by weight microcapsules comprising a polymer wall and a core composed predominantly of latent heat storage materials and
0-20% by weight water
and thermally curing the mixture.

12. The process according to claim 11, wherein at least one material selected from the group of materials consisting of wood fibers, natural fibers, wood chips and wood shavings are thermally cured in a mixture with the binder composition.

13. A binder composition comprising
40-95% by weight glue resin, calculated as solids,
5-40% by weight microcapsules comprising a polymer wall and a core composed predominantly of latent heat storage materials and
0-20% by weight water.
